(19) United States
(12) Patent Application Publication
(10) Pub. No.: US 2017/0276176 A1
(43) Pub. Date: Sep. 28, 2017

(54) BEARING APPARATUS AND PUMP

(71) Applicant: EBARA CORPORATION, Tokyo (JP)

(72) Inventors: Kazuya HIRATA, Tokyo (JP); Takashi YAMANAKA, Tokyo (JP); Shigeru YOSHIKAWA, Tokyo (JP); Dai KUDO, Tokyo (JP)

(21) Appl. No.: 15/517,036

(22) PCT Filed: Aug. 4, 2015
(86) PCT No.: PCT/JP2015/072145

§ 371 Date: Apr. 5, 2017

(30) Foreign Application Priority Data
Oct. 14, 2014 (JP) 2014-210089

(51) Int. Cl. F16C 33/10; F04D 29/06; F04D 29/046

(52) U.S. Cl. CPC F16C 33/103; F04D 29/046; F04D 29/061; F16C 33/1045

(57) ABSTRACT

A bearing apparatus is capable of stably supplying an appropriate amount of lubricating oil to a bearing with a simple arrangement, even if a peripheral speed of a rotational shaft increases. The bearing apparatus includes a bearing unit for receiving a load of a rotational shaft, a lubricating oil reservoir disposed below the bearing unit, and an oil disk rotatable together with the rotational shaft to scoop up lubricating oil stored in the lubricating oil reservoir. The oil disk has a side surface facing the bearing unit, the side surface having a groove formed therein. An outer-circumferential-side end surface of the groove extends parallel to an axial direction of the rotational shaft, and constitutes a guide surface for changing a direction of movement of the lubricating oil in the groove from a radial direction of the oil disk to the axial direction of the rotational shaft.

### TECHNICAL FIELD

The present invention relates to a bearing apparatus for use in a horizontal-shaft pump or the like, and more particularly to a bearing apparatus which is capable of appropriately supplying lubricating oil to a bearing even if a rotational shaft becomes larger in diameter or a rotational speed thereof is higher. Further, the present invention relates to a pump including such a bearing apparatus.

### BACKGROUND ART

Horizontal-shaft type of rotary machines (e.g., horizontal-shaft pumps), in which a rotational shaft is installed horizontally, have bearing apparatuses disposed in the vicinity of the ends of the rotational shaft in order to rotatably support the rotational shaft. Further, a lubricating oil reservoir that stores lubricating oil for lubricating and cooling the bearing is provided inside or outside the bearing apparatus.

Means for supplying the lubricating oil from the lubricating oil reservoir to the bearing includes a forced oil supply apparatus that uses external power and a self-lubrication device that uses no external power. The forced oil supply apparatus supplies the lubricating oil, by using external power, from the lubricating oil reservoir disposed outside of the bearing apparatus to the bearing disposed in the bearing apparatus. The self-lubrication device scoops up the lubricating oil, by using a rotational force of the rotational shaft, from the lubricating oil reservoir disposed below the rotational shaft in the bearing apparatus to supply the lubricating oil to the bearing.

FIGS. 16 and 17 show one example of the forced oil supply apparatus. FIG. 16 is a cross-sectional view of a bearing apparatus which uses a forced oil supply apparatus. FIG. 17 is a piping and instrumentation diagram of the forced oil supply apparatus.

As shown in FIG. 16, a horizontal-shaft pump 100 has a rotational shaft 1 which extends horizontally, and an end of the rotational shaft 1 is rotatably supported by bearings 9A, 9B. As shown in FIG. 17, one end of the rotational shaft 1 is coupled to an electric motor 200, and a forced oil supply apparatus 26 is disposed outside of the horizontal-shaft pump 100. The bearings 9A, 9B are forcibly supplied with lubricating oil from the forced oil supply apparatus 26. The forced oil supply apparatus 26 has a plurality of components including lubricating oil pumps 21, a filter 24, a lubricating oil cooler 23, a plurality of hydraulic pressure monitoring devices 25, and a lubricating oil tank 22. Therefore, the cost of the forced oil supply apparatus 26 becomes high.

Furthermore, an installation space for the forced oil supply apparatus 26 is required in addition to an installation space for the horizontal-shaft pump and the electric motor for driving this horizontal-shaft pump. As a result, an installation space required by the pump system in its entirety becomes large.

Next, a conventional bearing apparatus which uses a self-lubrication device will be described. Self-lubrication devices using an oil ring and using an oil disk have heretofore been put to use.

FIG. 18 is a cross-sectional view showing an example of a conventional bearing apparatus which uses an oil-ring-type self-lubrication device. As shown in FIG. 18, a rotational shaft 1 has an end rotatably supported by bearings 9A, 9B. A lubricating oil reservoir 10 for storing lubricating oil is disposed below the bearings 9A, 9B. Oil rings 20 are provided as a self-lubrication device for scooping up the lubricating oil in the lubricating oil reservoir 10. The oil rings 20 are disposed so as to surround an outer circumferential surface of the rotational shaft 1, and are rotated as the rotational shaft 1 rotates. The rotating oil rings 20 scoop up the lubricating oil in the lubricating oil reservoir 10, and supply the lubricating oil to the bearings 9A, 9B. The self-lubrication device which uses the oil rings 20 has heretofore been known as an oil-ring-type self-lubrication device.

However, with the conventional oil-ring-type self-lubrication device, when the peripheral speed of the outer circumferential surface of the rotational shaft 1 (hereinafter simply referred to as peripheral speed) increases due to an increase in the diameter of the rotational shaft 1, an increase in the speed of the rotational shaft 1 or the like, the rotation of the oil rings 20 cannot follow the rotation of the rotational shaft 1. Specifically, the rotational speed of the oil rings 20 greatly decreases compared with the rotational speed of the rotational shaft 1, so that the oil rings 20 cannot appropriately scoop up the lubricating oil. As a result, desired lubricating performance and cooling performance cannot be obtained.

On the other hand, an oil-disk-type self-lubrication device which uses an oil disk fixed to a rotational shaft, has no problem that the oil disk cannot follow the rotation of the rotational shaft, because the oil disk rotates together with the rotational shaft. However, when the rotational shaft rotates at a high speed, centrifugal force which acts on the lubricating oil scooped up by the oil disk, are increased. As a result, the lubricating oil scooped up by the oil disk is scattered only in radial direction of the oil disk, and cannot be supplied to a bearing which is disposed away from the oil disk in axial direction of the rotational shaft. Therefore, when the rotational shaft has an increased diameter or the rotational speed of the rotational shaft increases, it has been difficult to apply the conventional self-lubrication device to a bearing apparatus.

There has heretofore been known an oil-disk-type self-lubrication device which is improved for reliably guiding lubricating oil scooped up by an oil disk. The improved oil-disk-type self-lubrication device is shown in FIGS. 19(a) and 19(b). FIG. 19(a) is a vertical cross-sectional view showing an example of a conventional bearing apparatus which uses the oil-disk-type self-lubrication device, and FIG. 19(b) is an enlarged view of a section A in FIG. 19(a). In the oil-disk-type self-lubrication device shown in FIGS. 19(a) and 19(b), an oil disk 11 has a recess 80 formed in an outer circumferential end portion thereof. Further, a protrusion 81 projecting radially inwardly from an outer circumferential end of the recess 80, is formed. Lubricating oil scooped up by the oil disk 11 is held by the recess 80 and the protrusion 81, and carried to an oil receiver 82 that is disposed below the protrusion 81 in a higher position than a bearing 9. The oil receiver 82 is coupled to an oil supply hole 83 which guides the lubricating oil to a central region of the bearing 9. The lubricating oil held by the recess 80 and the protrusion 81 drops into the oil receiver 82, and then reaches the bearing 9 through the oil supply hole 83.

However, as the diameter of the rotational shaft 1 or the rotational speed thereof increases, centrifugal force which acts on the lubricating oil held by the recess 80 and the protrusion 81 increases, so that the lubricating oil continues to remain in the recess 80, and cannot drop into the oil receiver 8 as shown in FIG. 19(b). As a result, a new problem arises in that the lubricating oil supplied to the bearing 9 is not sufficient.

### CITATION LIST

### Patent Literature

Patent document 1: Japanese laid-open patent publication No. 06-165430

Patent document 2: Japanese laid-open patent publication No. 06-341437

### SUMMARY OF INVENTION

### Technical Problem

The present invention has been made in view of the various problems described above. It is therefore an object of the present invention to provide a bearing apparatus capable of stably supplying an appropriate amount of lubricating oil to a bearing with a simple arrangement, even if the peripheral speed of the rotational shaft increases. It is also an object of the present invention to provide a pump which includes such a bearing apparatus.

### Solution to Problem

One aspect of the present invention for achieving the above object provides a bearing apparatus including: a bearing unit for receiving a load of a rotational shaft; a lubricating oil reservoir disposed below the bearing unit; and an oil disk fixed to the rotational shaft and rotatable together with the rotational shaft to scoop up lubricating oil stored in the lubricating oil reservoir; wherein the oil disk has a side surface facing the bearing unit, the side surface having a groove formed therein; an outer-circumferential-side end surface of the groove extends parallel to an axial direction of the rotational shaft; the outer-circumferential-side end surface constitutes a guide surface for changing a direction of movement of the lubricating oil in the groove from a radial direction of the oil disk to the axial direction of the rotational shaft; and the outer-circumferential-side end surface is connected to the side surface of the oil disk.

In a preferred aspect of the present invention, the groove includes a plurality of grooves arranged around an axis of the oil disk.

In a preferred aspect of the present invention, the outer-circumferential-side end surface includes a large-diameter portion and a small-diameter portion located at different distances from the center of the oil disk.

In a preferred aspect of the present invention, the outer-circumferential-side end surface has a slope surface which is inclined obliquely with respect to the axial direction of the rotational shaft.

Another aspect of the present invention provides a bearing apparatus including: a bearing unit for receiving a load of a rotational shaft; a lubricating oil reservoir disposed below the bearing unit; and an oil disk fixed to the rotational shaft and rotatable together with the rotational shaft to scoop up lubricating oil stored in the lubricating oil reservoir; wherein the oil disk has a side surface facing the bearing unit, the side surface having a circumferential wall projecting toward the bearing unit and extending around the rotational shaft; an inner circumferential surface of the circumferential wall extends parallel to an axial direction of the rotational shaft; and the inner circumferential surface of the circumferential wall constitutes a guide surface for changing a direction of movement of the lubricating oil on the side surface of the oil disk from a radial direction of the oil disk to the axial direction of the rotational shaft.

In a preferred aspect of the present invention, the inner circumferential surface of the circumferential wall includes a large-diameter portion and a small-diameter portion located at different distances from the center of the oil disk.

In a preferred aspect of the present invention, the inner circumferential surface of the circumferential wall has a slope surface which is inclined obliquely with respect to the axial direction of the rotational shaft.

Another aspect of the present invention provides a bearing apparatus including: a bearing unit for receiving a load of a rotational shaft; a lubricating oil reservoir disposed below the bearing unit; and an oil disk fixed to the rotational shaft and rotatable together with the rotational shaft to scoop up lubricating oil stored in the lubricating oil reservoir; wherein the oil disk has a first side surface facing the bearing unit, a second side surface located opposite to the first side surface, and a plurality of through-holes extending from the first side surface to the second side surface; the through-holes have outer-circumferential-side surfaces extending parallel to an axial direction of the rotational shaft; and the outer-circumferential-side surfaces of the through-holes are connected to the first side surface and the second side surface of the oil disk.

In a preferred aspect of the present invention, the outer-circumferential-side surface includes a large-diameter portion and a small-diameter portion located at different distances from the center of the oil disk.

In a preferred aspect of the present invention, the outer-circumferential-side surface has a slope surface which is inclined obliquely with respect to the axial direction of the rotational shaft.

In a preferred aspect of the present invention, the bearing apparatus further includes: a second bearing unit for receiving the load of the rotational shaft; wherein the second side surface faces the second bearing unit.

Another aspect of the present invention provides a pump including: a rotational shaft; an impeller fixed to the rotational shaft; and the bearing apparatus described above, for rotatably supporting the rotational shaft.

### Advantageous Effects of Invention

According to the present invention, even when strong centrifugal force acts on the lubricating oil scooped up by the oil disk which rotates at a high peripheral speed, the outer-circumferential-side end surface of the groove formed in the oil disk prevents the lubricating oil from moving radially. As a result, the lubricating oil is prevented from being scattered only in a radial direction of the oil disk. Furtheimore, since the outer-circumferential-side end surface of the groove extends parallel to the axial direction of the rotational shaft, the outer-circumferential-side end surface serves as a guide surface for guiding the lubricating oil moved radially outwardly under the centrifugal force, in a direction parallel to the axial direction of the rotational shaft. Therefore, the oil disk enables the lubricating oil to being scattered in the axial direction of the rotational shaft. As a result, it is possible to stably supply the lubricating oil to the bearing unit which is located away from the oil disk in the axial direction of the rotational shaft. These advantages are also achieved in a case where the oil disk has a circumferential wall thereon or through-holes therein.

In this manner, according to the present invention, even under the high-peripheral-speed conditions in which it has been difficult for the conventional oil ring and oil disk to supply lubricating oil, it is possible to supply lubricating oil stably to the bearing unit in the bearing apparatus with a simple arrangement such as grooves, a circumferential wall, or through-holes. Therefore, since the applicable range of the bearing apparatus is widened without using a forced oil supply apparatus, the installation area for a pump is reduced and the cost of the pump is lowered, so that it is possible to provide a pump which is highly competitive.

### BRIEF DESCRIPTION OF DRAWINGS

FIG. 1 is a cross-sectional view showing an example of a horizontal-shaft single-stage pump which includes a bearing apparatus according to an embodiment of the present invention;

FIG. 2 is a cross-sectional view showing an example of a horizontal-shaft multi-stage pump which includes a bearing apparatus according to an embodiment of the present invention;

FIG. 3 is a cross-sectional view showing structure of a self-lubrication type bearing apparatus according to an embodiment of the present invention;

FIG. 4 is an enlarged cross-sectional view showing an oil disk and a guide casing of the self-lubrication type bearing apparatus according to the embodiment of the present invention;

FIG. 5(a) is a plan view showing an example of a conventional oil disk;

FIG. 5(b) is a vertical cross-sectional view of the oil disk shown in FIG. 5(a);

FIG. 6(a) is a schematic view illustrating a behavior of lubricating oil when the conventional oil disk rotates at a high speed, and is a plan view of the oil disk;

FIG. 6(b) is a schematic view illustrating the behavior of lubricating oil when the conventional oil disk rotates at a high speed, and is a partial cross-sectional view of the oil disk;

FIG. 7(a) is a plan view of an oil disk according to an embodiment of the present invention;

FIG. 7(b) is a vertical cross-sectional view of the oil disk shown in FIG. 7(a);

FIG. 8 is an enlarged schematic view showing a groove which is formed in the oil disk shown in FIG. 7(b);

FIGS. 9(a) and 9(b) are schematic views illustrating a behavior of lubricating oil when the oil disk shown in FIGS. 7(a) and 7(b) rotates at a high speed;

FIG. 10 is a graph showing experimental results for comparing a temperature of a bearing unit in a case where a rotational shaft rotates with use of a bearing apparatus in which the conventional oil disk shown in FIGS. 5(a) and 5(b) is assembled, with a temperature of a bearing unit in a case where a rotational shaft rotates with use of a bearing apparatus in which the oil disk shown in FIGS. 7(a) and 7(b) is assembled;

FIG. 11 is a plan view showing a modified example of the oil disk shown in FIGS. 7(a) and 7(b);

FIG. 12(a) is a plan view of an oil disk according to another embodiment of the present invention;

FIG. 12(b) is a vertical cross-sectional view of the oil disk shown in FIG. 12(a);

FIG. 13(a) is a plan view of an oil disk according to still another embodiment of the present invention;

FIG. 13(b) is a partial cross-sectional view of the oil disk shown in FIG. 13(a);

FIGS. 14(a) through 14(d) are views showing cross-sectional shapes of outer-circumferential-side end surfaces of grooves according to various modified examples;

FIGS. 15(a) and 15(b) are views showing cross-sectional shapes of outer-circumferential-side end surfaces of grooves according to still another modified examples;

FIG. 16 is a cross-sectional view of a bearing apparatus which uses a forced oil supply apparatus;

FIG. 17 is a piping and instrumentation diagram of the forced oil supply apparatus;

FIG. 18 is a cross-sectional view showing an example of a conventional bearing apparatus which uses an oil-ring-type self-lubrication device;

FIG. 19(a) is a vertical cross-sectional view showing an example of a conventional bearing apparatus which uses an oil-disk-type self-lubrication device; and

FIG. 19(b) is an enlarged view of a section A in FIG. 19(a).

### DESCRIPTION OF EMBODIMENTS

Embodiments of the present invention will be described below with reference to the drawings. In the present specification, a polar coordinate system whose origin is located at a central axis of a rotational shaft of a pump, is defined. In this polar coordinate system, a longitudinal direction of the rotational shaft is referred to as an axial direction, a direction perpendicular to the axial direction is referred to as a radial direction, and a direction around the outer circumferential surface of the rotational shaft is referred to as a circumferential direction.

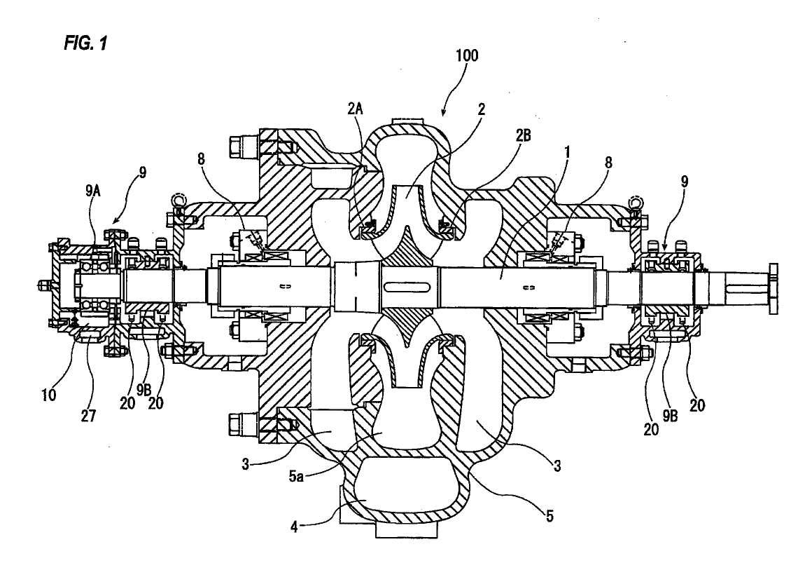

FIG. 1 is a cross-sectional view showing an example of a horizontal-shaft single-stage pump which includes a bearing apparatus according to an embodiment of the present invention. The horizontal-shaft single-stage pump 100 as a rotary machine shown in FIG. 1 has an impeller 2 and a rotational shaft 1 to which the impeller 2 is fixed. The rotational shaft 1 extends horizontally. One end of the rotational shaft 1 is coupled to a driving machine such as an electric motor (not shown), and the rotational shaft 1 and the impeller 2 is rotated by this driving machine. Further, the rotational shaft 1 is rotatably supported by bearing apparatuses 9, 9 provided in the vicinity of both ends thereof.

The impeller 2 is disposed in a pump casing 5. The pump casing 5 shown in FIG. 1 has a volute casing 5a therein, and the impeller 2 is disposed within the volute casing 5a. When the impeller 2 is rotated as the rotational shaft 1 rotates, a liquid such as water is sucked from suction ports 3, a pressure of the liquid is increased by actions of the impeller 2 and the volute casing 5a, and then the liquid is discharged from an outlet port 4.

The impeller 2 in the illustrated example has a double-suction structure for sucking the liquid from both sides thereof. Liquid inlets of the impeller 2 are equipped with mouth rings 2A, 2B, respectively. These mouth rings 2A, 2B are designed to have different diameters, so that a thrust force due to a differential pressure is applied in one direction along the rotational shaft 1 to allow the rotational shaft 1 to rotate stably. The thrust force is supported by a thrust bearing unit 9A of the bearing apparatus 9. Since the thrust force acts as a load on the thrust bearing unit 9A, it is necessary to supply an appropriate amount of lubricating oil to the thrust bearing unit 9A to cool the thrust bearing unit 9A while lubricating it. Therefore, the bearing apparatus 9, which will be described later, according to the embodiment of the present invention is provided. The thrust bearing unit 9A is lubricated and cooled by lubricating oil stored in a lubricating oil reservoir 10, and the lubricating oil in the lubricating oil reservoir 10 is cooled by a cooling jacket 27 attached to the lubricating oil reservoir 10.

In addition to this thrust bearing unit 9A, two radial bearing units 9B, 9B are disposed in the vicinity of the both ends of the rotational shaft 1. The rotational shaft 1 is supported by the two radial bearing units 9B, 9B and the one thrust bearing unit 9A. In the present embodiment, sleeve-type bearings are used as the radial bearing units 9B, and conventional self-lubrication devices with oil rings 20 are used as the sleeve-type radial bearing units 9B, 9B.

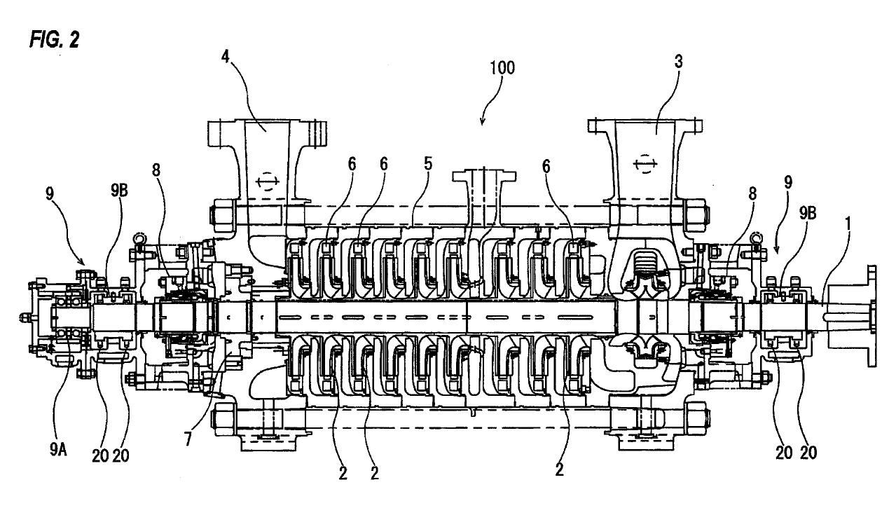

FIG. 2 is a cross-sectional view showing an example of a horizontal-shaft multi-stage pump which includes a bearing apparatus according to an embodiment of the present invention. The horizontal-shaft multi-stage pump 100 as a rotary machine shown in FIG. 2 has a plurality of impellers 2 and a rotational shaft 1 to which the impellers 2 are fixed. The rotational shaft 1 extends horizontally. The plurality of impellers 2 are arranged in series on the rotational shaft 1, and a plurality of guide vanes 6 are disposed so as to surround each of these impellers 2. One end of the rotational shaft 1 is coupled to a driving machine such as an electric motor (not shown), and the rotational shaft 1 and the impellers 2 are rotated by this driving machine. Further, the rotational shaft 1 is rotatably supported by bearing apparatuses 9, 9 provided in the vicinity of both ends thereof.

The impellers 2 are disposed in a pump casing 5. When the impellers 2 are rotated as the rotational shaft 1 rotates, a liquid such as water is sucked from a suction port 3, a pressure of the liquid is increased by actions of the impellers 2 and the guide vanes 6, and then the liquid is discharged from an outlet port 4. Since the plurality of impellers 2 are arranged so as to face in the same direction, thrust forces generated by differential pressures between the adjacent impellers 2 are superposed by the number of impellers 2, thereby generating a large thrust force. This thrust force is canceled out by a balancing device 7 provided in the horizontal-shaft multi-stage pump 100. However, during transient operation, a certain amount of thrust force remains. This remaining thrust force is supported by a thrust bearing unit 9A of the bearing apparatus 9. Since the remaining thrust force acts as a load on the thrust bearing unit 9A, it is necessary to supply an appropriate amount of lubricating oil to the thrust bearing unit 9A to cool the thrust bearing unit 9A while lubricating it.

In addition to the thrust bearing unit 9A, two radial bearing units 9B, 9B are disposed in the vicinity of the both ends of the rotational shaft 1. The rotational shaft 1 is supported by the two radial bearing units 9B, 9B and the one thrust bearing unit 9A. In the present embodiment, sleeve-type bearings are used as the radial bearing units 9B, 9B, and conventional self-lubrication devices with oil rings 20 are used as the sleeve-type radial bearing units 9B, 9B. The structure of the bearing apparatuses 9, 9 disposed in the vicinity of the both ends of the rotational shaft 1 is the same as the structure of those in the horizontal-shaft single-stage pump shown in FIG. 1.

In either one of the horizontal-shaft pumps 100 shown in FIGS. 1 and 2, the rotational shaft 1 extends through the pump casing 5. Gaps formed between the rotational shaft 1 and the pump casing 5 are sealed by shaft seal devices 8, 8 such as mechanical seals, respectively. Therefore, the liquid whose pressure has been increased by the impeller(s) 2 does not enter the bearing apparatuses 9, 9.

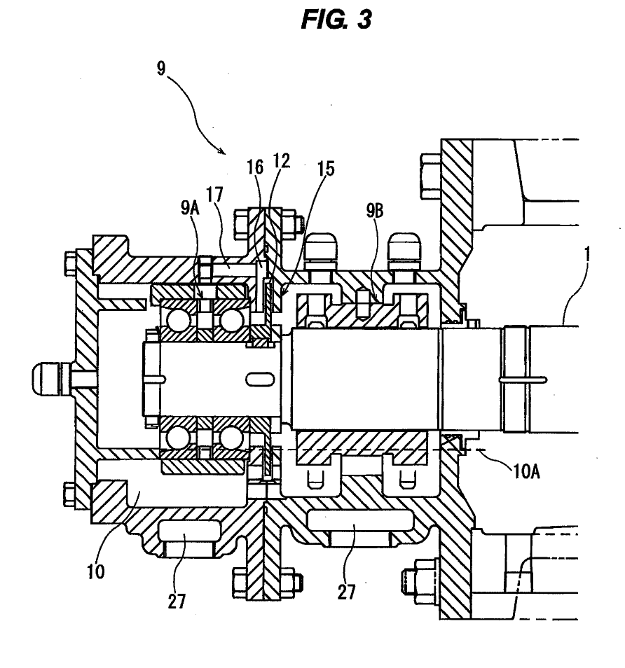

FIG. 3 is a cross-sectional view showing structure of a self-lubrication type bearing apparatus according to an embodiment of the present invention. This self-lubrication type bearing apparatus is used in the horizontal-shaft pump 100 shown in FIG. 1 or FIG. 2. As shown in FIG. 3, this bearing apparatus 9 has a thrust bearing unit 9A for receiving an axial load and a radial load of the rotational shaft 1 that extends horizontally, and a radial bearing unit 9B for supporting a radial load of the rotational shaft 1. In the thrust bearing unit 9A, a plurality of angular ball bearings are used.

A lubricating oil reservoir 10 is disposed below the thrust bearing unit 9A and the radial bearing unit 9B, and a free surface (lubricating oil surface) of lubricating oil stored in the lubricating oil reservoir 10 is indicated by a dotted line with a symbol 10A. The amount of lubricating oil is controlled such that the free surface 10A in the lubricating oil reservoir 10 is constant. A cooling jacket 27 is provided below the lubricating oil reservoir 10, and the lubricating oil in the lubricating oil reservoir 10 is cooled by a coolant flowing through the cooling jacket 27. Instead of the cooling jacket 27, a finned air cooling structure may be employed. Alternatively, a finned coolant tube may be inserted in the lubricating oil reservoir 10 for directly cooling the lubricating oil.

The bearing apparatus 9 includes an oil disk 12 disposed between the thrust bearing unit 9A and the radial bearing unit 9B and fixed to the rotational shaft 1. Since the oil disk 12 is fixed to the rotational shaft 1, the oil disk 12 rotates at the same rotational speed as the rotational shaft 1 at all times. A lower portion of the oil disk 12 is immersed in the lubricating oil in the lubricating oil reservoir 10. The oil disk 12 is rotated as the rotational shaft 1 rotates, thereby scooping up the lubricating oil stored in the lubricating oil reservoir 10. As shown in FIG. 3, the bearing apparatus 9 has a guide casing 15 for preventing the lubricating oil, scooped up by the oil disk 12, from being scattered into unwanted regions in the bearing apparatus.

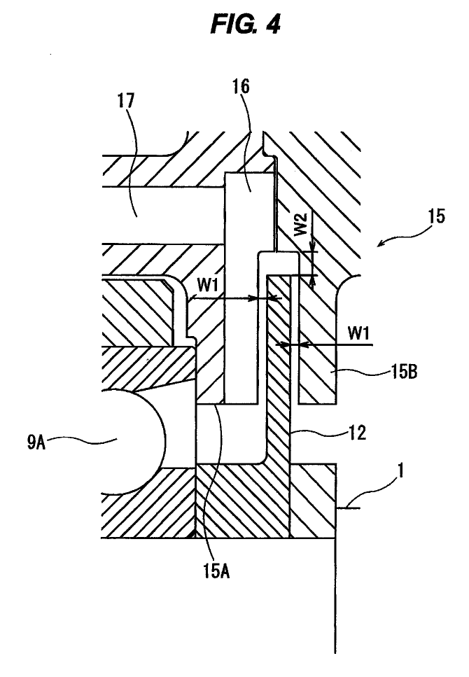

FIG. 4 is an enlarged cross-sectional view showing the oil disk 12 and the guide casing 15. As shown in FIG. 4, the guide casing 15 is formed by two annular guide disks 15A, 15B which are disposed to face both side surfaces of the oil disk 12. The guide disks 15A, 15B cover both side surfaces and outer circumferential surface of the oil disk 12, and are housed in the bearing apparatus 9. In the embodiment shown in FIG. 4, the guide casing 15 is formed by the two guide disks 15A, 15B arranged so as to interpose a peripheral edge portion (which is an area including the outer circumferential surface) of the oil disk 12. Alternatively, the guide casing 15 may be foil led by a single component enclosing the peripheral edge portion of the oil disk 12.

The guide disks 15A, 15B have inner surfaces located closely to the both side surfaces and outer circumferential surface of the oil disk 12, and these inner surfaces of the guide disks 15A, 15B face the both side surfaces and outer circumferential surface of the oil disk 12. An axial gap W1 and a radial gap W2 are formed between the oil disk 12 and the guide casing 15. The axial gap (clearance) W1 is a gap between the side surface of the oil disk 12 and the guide casing 15, and the radial gap (clearance) W2 is a gap between the outer circumferential surface of the oil disk 12 and the guide casing 15.

The gaps W1, W2 are appropriately designed and set on the basis of the viscosity and temperature of the lubricating oil to be used, and pump operating conditions such as the rotational speed of the rotational shaft 1. The lubricating oil scooped up by the oil disk 12 is guided through a lubricating oil passage 17 to the thrust bearing unit 9A.

An inner surface (inner side surface) of the guide casing 15 which faces the side surface of the oil disk 12 is provided with a lubricating oil introducing groove 16. The lubricating oil introducing groove 16 has an upper end portion connected to the lubricating oil passage 17, and is located closely to the side surface of the oil disk 12.

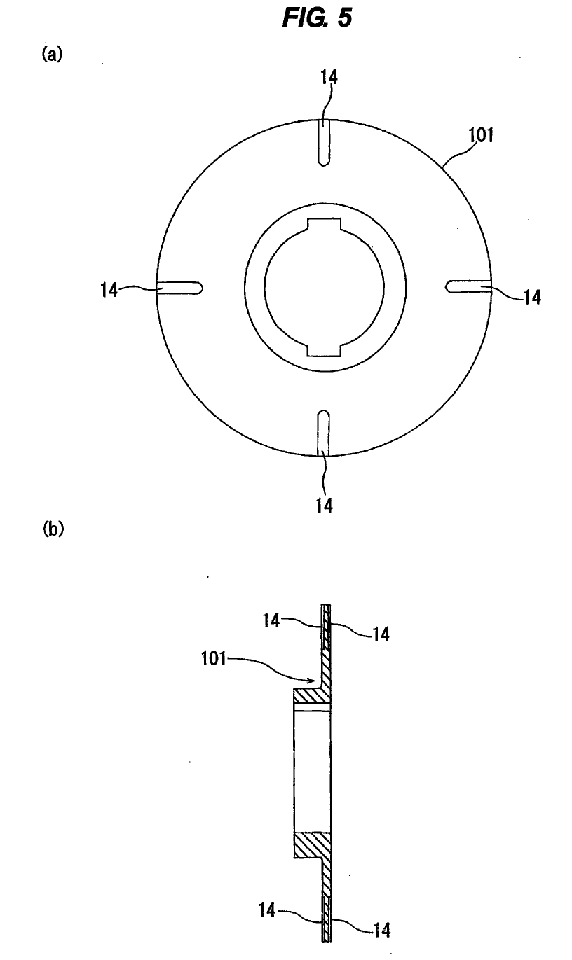

FIG. 5(a) is a plan view showing an example of a conventional oil disk, and FIG. 5(b) is a vertical cross-sectional view of the oil disk shown in FIG. 5(a). As shown in FIGS. 5(a) and 5(b), in each of side surfaces of the conventional oil disk 101, four radial grooves 14 extending in radial directions of the oil disk 101 are formed. These radial grooves 14 extend to an outer circumferential surface of the oil disk 101, and thus an outer end of each radial groove 14 is located on the outer circumferential surface of the oil disk 101. When the oil disk 101 rotates, the lubricating oil is held and scooped up by the radial grooves 14 formed in the both side surfaces of the oil disk 101.

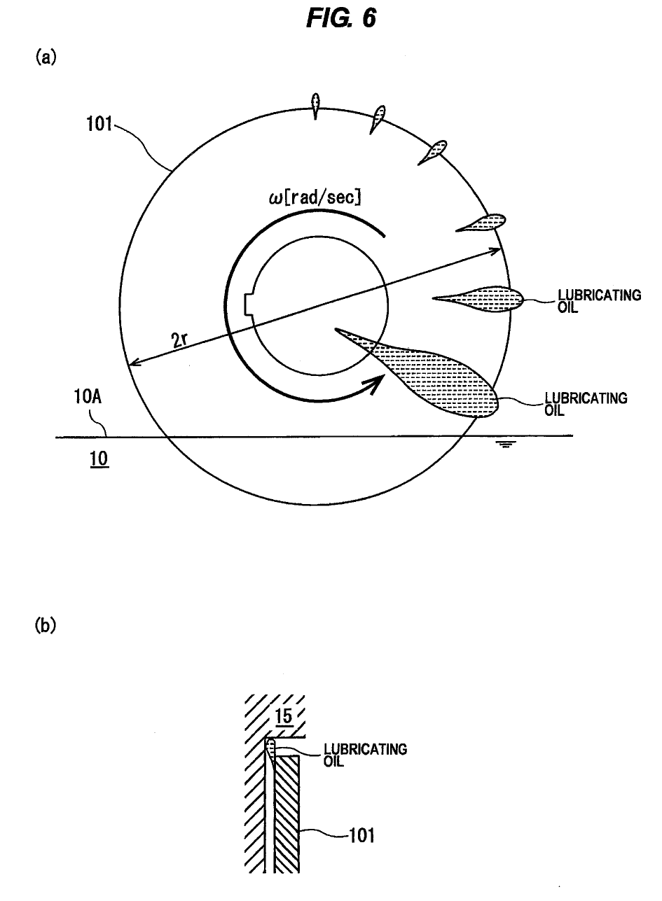

FIGS. 6(a) and 6(b) are schematic views illustrating a behavior of lubricating oil when the oil disk 101 rotates at a high speed. More specifically, FIG. 6(a) is a plan view of the oil disk 101, and FIG. 6(b) is a partial cross-sectional view of the oil disk 101. With reference to FIGS. 6(a) and 6(b), the behavior of the lubricating oil that is attached to the surface of the oil disk 101 and scooped up when the rotational speed of the oil 101 increases, will be described below.

In addition to the gravitational force, surface tension, and frictional forces, centrifugal force generated by the rotation of the oil disk 101 acts on the lubricating oil attached to the surfaces of the oil disk 101. This centrifugal force is proportional to the mass of the lubricating oil and the distance from the center of the oil disk 101 to the lubricating oil, and is also proportional to the square of the angular speed of the oil disk 101.

When the rotational speed of the oil disk 101 is low, the lubricating oil attached to the oil disk 101 does not largely change its position, and is rotated while being held on the oil disk 101. As the rotational speed of the oil disk 101 increases, the centrifugal force acting on the lubricating oil attached to the oil disk 101 becomes greater, so that the lubricating oil is moved outwardly in the radial direction of the oil disk 101. Thus, a relatively large amount of lubricating oil gathers on the outer circumferential edge of the oil disk 101. Therefore, the oil disk 101 which has the radial grooves 14 as shown in FIGS. 5(a) and 5(b) can keep the large amount of lubricating oil on the outer circumferential edge thereof, and can carry the lubricating oil to a top portion of the oil disk 101.

However, as the rotational speed further increases, the centrifugal force becomes dominant over the gravitational force, surface tension, and frictional forces acting on the lubricating oil on the oil disk 101. Therefore, the lubricating oil attached to the surfaces of the oil disk 101 tend to be scattered outwardly in the radial direction of the oil disk 101, irrespective of the surface tension, frictional forces due to viscosity, and the gravitational force. Specifically, when the rotational speed of the oil disk 101 is very high, a sufficient amount of lubricating oil cannot be supplied to the bearing unit 9A, because the lubricating oil cannot be scattered in the axial direction of the rotational shaft 1.

For example, it is assumed that the radius r of the oil disk 101 is 90 mm and the rotational speed of the rotational shaft 1 (i.e., the rotational speed of the oil disk 101 fixed to the rotational shaft 1) is 3600 min⁻¹ as pump operating conditions. In this case, when the pump is in operation, the centrifugal acceleration r ω² of centrifugal force generated on the oil disk 101 is greater than 1300 times the gravitational acceleration, as indicated by the following equation (1):

$$Centrifugal acceleration \text{/} gravitational acceleration = r {ω}^{2} \text{/} 9.8 = ( 90 \text{/} 1000 ) \cdot {( 2 π \times 3600 \text{/} 60 )}^{2} \text{/} 9.8 \approx 1304 \qquad ( 1 )$$

Specifically, since centrifugal force with the acceleration greater than 1300 times the gravitational acceleration are generated in the lubricating oil attached to the surfaces of the oil disk 101, this centrifugal force become dominant.

The lubricating oil attached to the surfaces of the oil disk 101 tends to stay on the surfaces of the oil disk 10 by surface tension and frictional forces. However, in the situation where the centrifugal force is dominant as described above, the large centrifugal force that is much greater than the gravitational force, surface tension, and frictional forces causes the lubricating oil on the surfaces of the oil disk 10 to move outwardly in the radial direction of the oil disk 101.

The centrifugal force generated by the rotation of the oil disk 101 acts over the entire circumference of the oil disk 101. Therefore, as shown in FIG. 6(a), the lubricating oil, scooped up from the lubricating oil reservoir 10 and attached to the surfaces of the oil disk 101, is scattered radially outwardly off the oil disk 101 by the strong centrifugal force, immediately after it has appeared on the free surface 10A of the lubricating oil reservoir 10. Therefore, in the high-speed rotating condition in which the centrifugal force is dominant, the conventional oil disk 101 shown in FIGS. 5(a) and 5(b) is unable to scoop up the lubricating oil to the top portion of the oil disk 101. If the oil disk 101 fails to scoop up a sufficient amount of lubricating oil, the lubricating oil cannot be supplied to the bearing unit 9A which is located away from the oil disk in the axial direction of the rotational shaft 1.

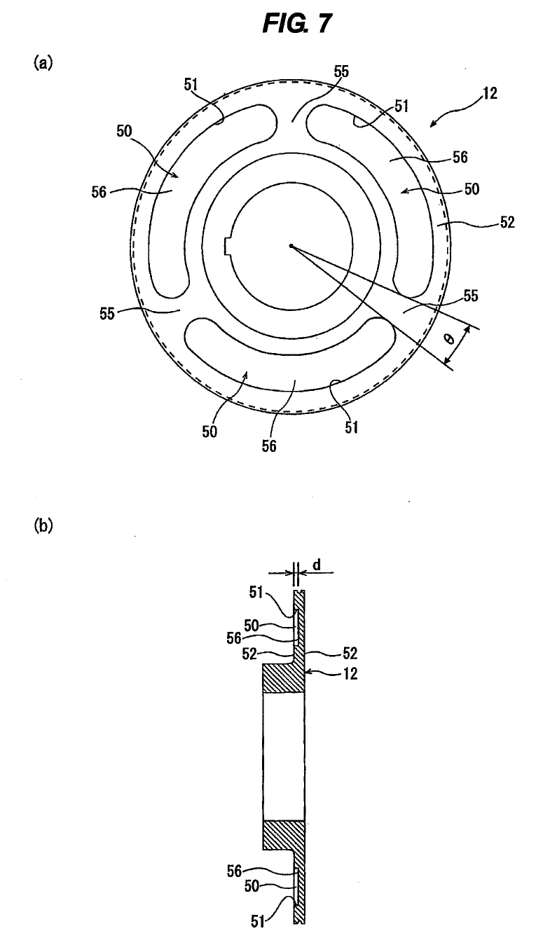

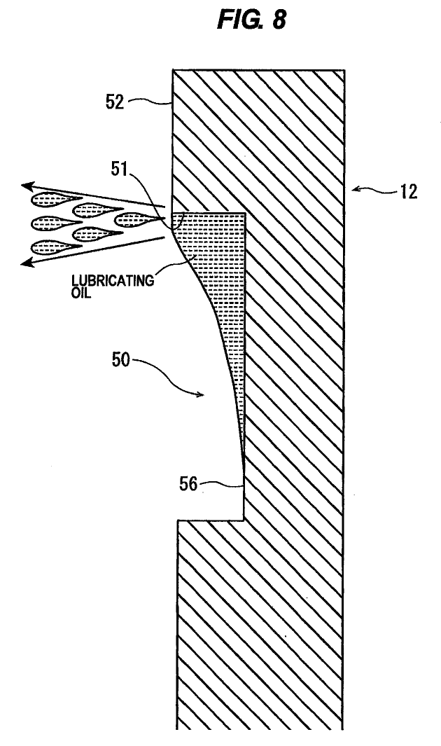

An embodiment of an oil disk 12 capable of solving the above problems is shown in FIGS. 7(a), 7(b), and FIG. 8. FIG. 7(a) is a plan view of the oil disk 12 according to an embodiment of the present invention, and FIG. 7(b) is a vertical cross-sectional view of the oil disk 12 shown in FIG. 7(a). FIG. 8 is an enlarged schematic view showing a portion of the oil disk 12 shown in FIG. 7(b).

As shown in FIGS. 7(a) and 7(b), the oil disk 12 according to the present embodiment has a side surface 52 perpendicular to the axial direction of the rotational shaft 1. This side surface 52 has a plurality of (three in the illustrated example) grooves 50 formed therein, which are arranged around the axis of the oil disk 12 (i.e., the rotational shaft 1) at equal intervals. Each groove 50 is of an arcuate shape extending in a circumferential direction of the oil disk 12. Each groove 50 has a depth d defined as a distance from the side surface 52 of the oil disk 12 to the bottom surface 56 of the groove 50. As shown in FIG. 7(b) and FIG. 8, the groove 50 has an outer-circumferential-side end surface 51 extending parallel to the axial direction of the rotational shaft 1. The outer-circumferential-side end surface 51 is connected to the side surface 52 of the oil disk 12 at right angle. The oil disk 12 is disposed such that the side surface 52 faces the bearing unit 9A (see FIG. 3).

As shown in FIG. 7(a), there are three grooves 50 formed in the side surface 52 of the oil disk 12 according to the present embodiment. Therefore, the side surface 52 of the oil disk 12 has areas 55 where the grooves 50 do not exist. If the areas 55 where the grooves 50 do not exist, are too large, the side surface 52 of the oil disk 12 becomes close to the side surface of the conventional oil disk 101 which is flat. As a result, the advantages (described later) of the present embodiment cannot be obtained. The sum of angles θ between adjacent grooves 50 is preferably equal to or smaller than 40% of the total circumference (i.e., 360°) of the oil disk 12, and more preferably is equal to or smaller than 30% of the total circumference of the oil disk 12.

The grooves 50 may be replaced with a single groove extending over an entire circumference of the side surface 52 of the oil disk 12. In this case, due to a concern that the lubricating oil may not appropriately be held by the single groove 50, (i.e., a concern about the wetting property of the lubricating oil), the wetting property of the lubricating oil with respect to the groove 50 should preferably be adjusted by suitably selecting a surface roughness of the groove 50 or a material of the oil disk 12.

In the present embodiment, the grooves 50 are formed in one side surface 52 of the oil disk 12. The grooves 50 may be formed in both of the side surface (first side surface) 52 facing the bearing unit 9A and the side surface (second side surface) 52 facing the bearing unit 9B. In this case, the lubricating oil is scooped up by the both side surfaces 52 of the oil disk 12 and supplied to the two bearing units 9A, 9B disposed at both sides of the oil disk 12. Instead of the grooves 50 formed in both side surfaces 52 of the oil disk 12, through-holes, which will be described later, may be forming in the oil disk 12.

When the oil disk 12 having such structures is rotated, the lubricating oil in each groove 50 is forced against the outer-circumferential-side end surface 51 of the groove 50 by action of centrifugal force, as shown in FIG. 8. The lubricating oil forced against the outer-circumferential-side end surface 51 by the centrifugal force cannot move outwardly in the radial direction of the oil disk 12. Specifically, the outer-circumferential-side end surface 51 can prevent the lubricating oil from moving radially and from being scattered only in the radial direction of the oil disk 12.

Further, since the outer-circumferential-side end surface 51 of the groove 50 extends parallel to the axial direction of the rotational shaft 1, the lubricating oil that has been moved outwardly in the radial direction of the oil disk 12 by the centrifugal force changes its direction of movement to an axial direction of the rotational shaft 1 by colliding with the outer-circumferential-side end surface 51 of the groove 50, and then leaves the oil disk 12. As a result, the lubricating oil can be scattered in a direction along which the outer-circumferential-side end surface 51 extends and in a direction in which the groove 50 opens, i.e., in the axial direction of the rotational shaft 1. In this manner, the outer-circumferential-side end surface 51 serves as a guide surface for changing the direction of movement of the lubricating oil in the groove 50 from the radial direction of the oil disk 12 to the axial direction of the rotational shaft 1.

The velocity component of the lubricating oil that is scattered in the axial direction of the rotational shaft 1 is produced by converting of a dynamic pressure in the radial direction which is generated in the lubricating oil by the strong centrifugal force, or a static pressure of the lubricating oil which is increased by the outer-circumferential-side end surface 51, into a dynamic pressure in the axial direction that has been changed from the radial direction by the outer-circumferential-side end surface 51. Therefore, the scattering speed of the lubricating oil on which the strong centrifugal force acts, becomes very high. The direction in which the lubricating oil is scattered is affected by an angle of the outer-circumferential-side end surface 51 of the groove 50 with respect to the axial direction of the rotational shaft 1. In order to supply the lubricating oil most effectively to the bearing unit 9A that is located away from the oil disk 12 in the axial direction of the rotational shaft 1, it is preferred that the outer-circumferential-side end surface 51 extends parallel to the axial direction of the rotational shaft 1 (i.e., perpendicular to the side surface 52 of the oil disk 12). Specifically, it is preferred that the outer-circumferential-side end surface 51 is connected to the side surface 52 of the oil disk 12 at right angle.

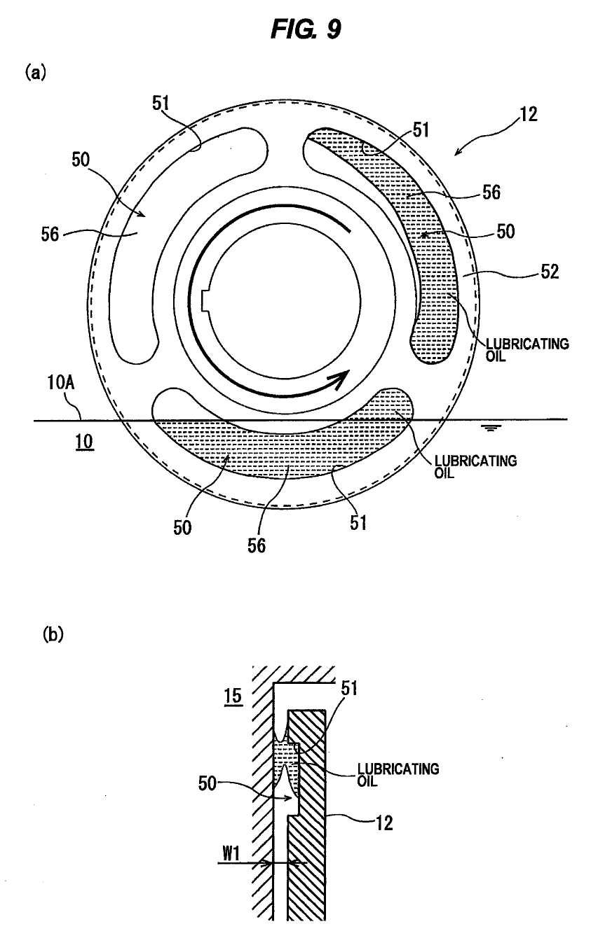

With reference to FIGS. 9(a) and 9(b), a behavior of the lubricating oil scattered in the axial direction of the rotational shaft 1 will be described below. FIGS. 9(a) and 9(b) are schematic views illustrating a behavior of lubricating oil when the oil disk 12 shown in FIGS. 7(a) and 7(b) rotates at a high speed. Specifically, FIG. 9(a) is a plan view of the oil disk 12, and FIG. 9(b) is a partial cross-sectional view of the oil disk 12.

As shown in FIG. 9(a), when the groove 50 forming in the oil disk 12 is immersed in the lubricating oil in the lubricating oil reservoir 10, the lubricating oil is attached to the outer-circumferential-side end surface 51 and the bottom surface 56 of the groove 50. When the oil disk 12 rotates until the groove 50 appears above the free surface 10A of the lubricating oil, the lubricating oil in the groove 50 is moved radially outwardly under the action of centrifugal force. The lubricating oil that has been moved radially outwardly in the groove 50 collides with the outer-circumferential-side end surface 51, and cannot move radially outwardly beyond the outer-circumferential-side end surface 51. As a result, the lubricating oil is held in the groove 50. The lubricating oil that has collided with the outer-circumferential-side end surface 51 changes its direction of movement into a direction along the outer-circumferential-side end surface 51 parallel to the axial direction of the rotational shaft 1, and is scattered from the groove 50 of the oil disk 12 in the axial direction of the rotational shaft 1. The scattered lubricating oil flows through the lubricating oil introducing groove 16, formed in the guide casing 15 shown in FIG. 4, into the lubricating oil passage 17. As a result, the lubricating oil is stably supplied to the bearing unit 9A that is located away from the oil disk 12 in the axial direction of the rotational shaft 1.

To sum up, even when the strong centrifugal force acts on the lubricating oil attached to the oil disk 12, the outer-circumferential-side end surface 51 prevents the lubricating oil from being scattered outwardly in the radial direction of the oil disk 12. Furthermore, since the outer-circumferential-side end surface 51 of the groove 50 extends parallel to the axial direction of the rotational shaft 1, the lubricating oil that has moved radially on the oil disk 12 by the centrifugal force is forced to change its direction of movement by the outer-circumferential-side end surface 51 and is scattered in the axial direction of the rotational shaft 1.

An amount of lubricating oil held in the groove 50, i.e., an amount of lubricating oil to be scattered from the oil disk 12 in the axial direction of the rotational shaft 1, varies depending on the depth d of the groove 50. Therefore, it is possible to optimize the amount of lubricating oil supplied to the bearing unit 9A by appropriately setting the depth d of the groove 50. As a result, an increase in rolling friction of the bearing due to an excessive supply of lubricating oil to the bearing unit 9A can be prevented. Further, an increase in temperature of the bearing due to increased rolling friction can be prevented.

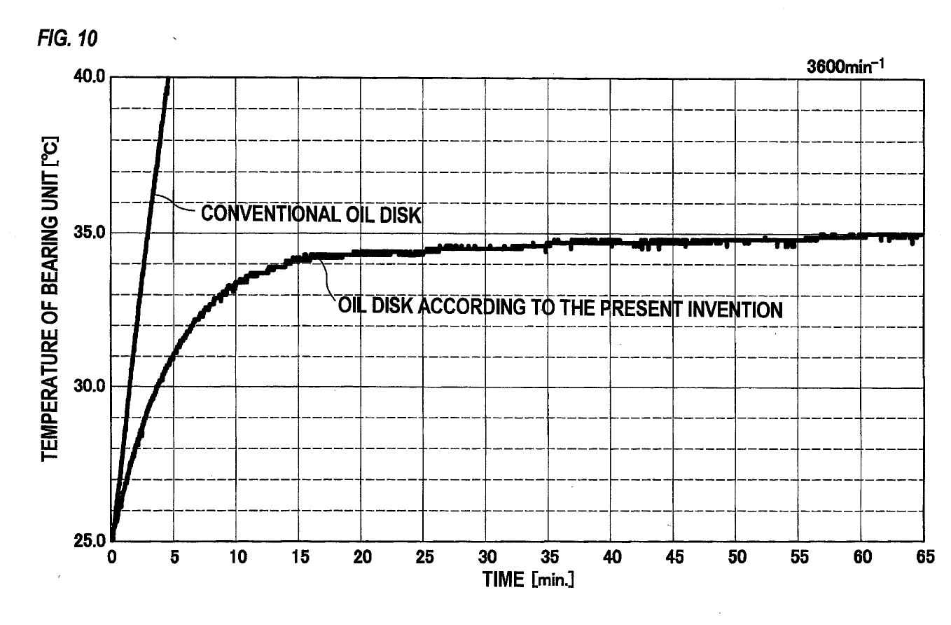

Experiments were carried out to measure changes in the temperature of the bearing unit 9A when the oil disk 12 according to the above embodiment and the conventional oil disk 101 shown in FIGS. 5(a) and 5(b) were assembled into the bearing apparatus shown in FIG. 3, and when the rotational shaft 1 was rotated. FIG. 10 shows the results of the experiments. In FIG. 10, vertical axis represents temperature of the bearing unit 9A, and horizontal axis represents operating time during which the rotational shaft 1 rotated. The rotational speed of the rotational shaft 1 was set to 3600 min⁻¹. The gaps W1, W2 (see FIG. 4) between the oil disks 101, 12 and the guide casing 15 were set to 4 mm and 10 mm, respectively. Furthermore, the guide casing 15 of the bearing apparatus was made of a transparent acrylic resin, and a flowing manner of the lubricating oil in the bearing apparatus was observed.

As shown in FIG. 10, in the bearing apparatus which incorporated the conventional oil disk 101, the temperature of the bearing unit 9A continued to steeply rise from the start of operation thereof. In contrast, in the bearing apparatus which incorporated the oil disk 12 according to the present embodiment, the increase of the temperature stopped at near 35° C., bringing about a state of temperature equilibrium.

Further, the flowing manner of the lubricating oil during the operation was observed. As for the conventional oil disk 101, it was observed that the lubricating oil was scattered in the radial direction of the oil disk 101 and was not supplied to the bearing unit 9A. As for the oil disk 12 according to the present embodiment, it was observed that the lubricating oil was scattered in the axial direction of the rotational shaft 1 and was supplied to the bearing unit 9A.

From these experimental results, it can be understood that the conventional oil disk 101 caused inadequate lubrication and resultant heating and inadequate cooling because it failed to appropriately supply the lubricating oil to the bearing unit 9A. In contrast, it can be seen from the experimental results that the oil disk 12 according to the present embodiment assisted appropriate lubrication, heating suppression, and cooling because it was able to appropriately supply the lubricating oil to the bearing unit 9A.

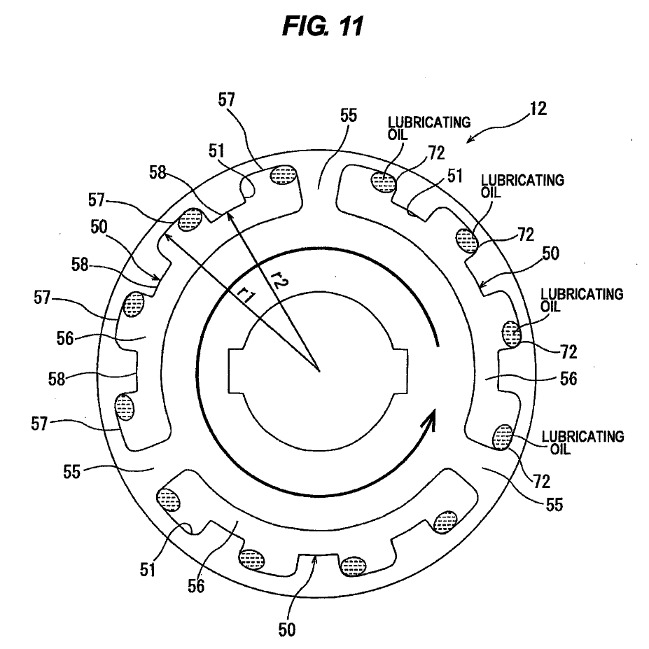

A modified example of the oil disk 12 will be described below with reference to FIG. 11. FIG. 11 is a plan view showing a modified example of the oil disk 12 shown in FIG. 7(a).

As shown in FIG. 11, in this embodiment, the outer-circumferential-side end surface 51 of each groove 50 is constituted by large-diameter portions 57 whose distance from the center of the oil disk 12 is relatively large and small-diameter portions 58 whose distance from the center of the oil disk 12 is relatively small. These large-diameter portions 57 and small-diameter portions 58 are alternately successively joined to each other. Where a distance from the center of the oil disk 12 to outer-circumferential-side end surface 51 at the large-diameter portion 57 is represented by r1 and a distance from the center of the oil disk 12 to outer-circumferential-side end surface 51 at the small-diameter portion 58 is represented by r2, r1 is larger than r2. As described above, the centrifugal force, which is proportional to a position in the radial direction on the oil disk 12, acts on the lubricating oil attached to the oil disk 12. Therefore, according to the embodiment shown in FIG. 11, the centrifugal force acting on the lubricating oil on the large-diameter portions 57 and the centrifugal force acting on the lubricating oil on the small-diameter portions 58 can be made different from each other. As a result, a scattering distance of the lubricating oil from the large-diameter portions 57 and a scattering distance of the lubricating oil from the small-diameter portions 58 are made different from each other in the axial direction of the rotational shaft 1, so that the lubricating oil can be supplied to a wide range in the axial direction of the rotational shaft 1.

Since the oil disk 12 rotates at a high speed, the amount of lubricating oil held by the outer-circumferential-side end surface 51 of the groove 50 is not uniform along the circumferential direction of the oil disk 12. In the embodiment shown in FIG. 11, therefore, the lubricating oil can be unevenly held by corners 72 of the large-diameter portions 57 of the grooves 50 depending on operating conditions. Since the number of large-diameter portions 57 of the grooves 50 (i.e., the number of corners 72) can suitably be selected, the amount of lubricating oil held in the grooves 50 of the oil disk 12 can be adjusted. As a result, it is possible to adjust the amount of lubricating oil supplied to the bearing unit 9A.

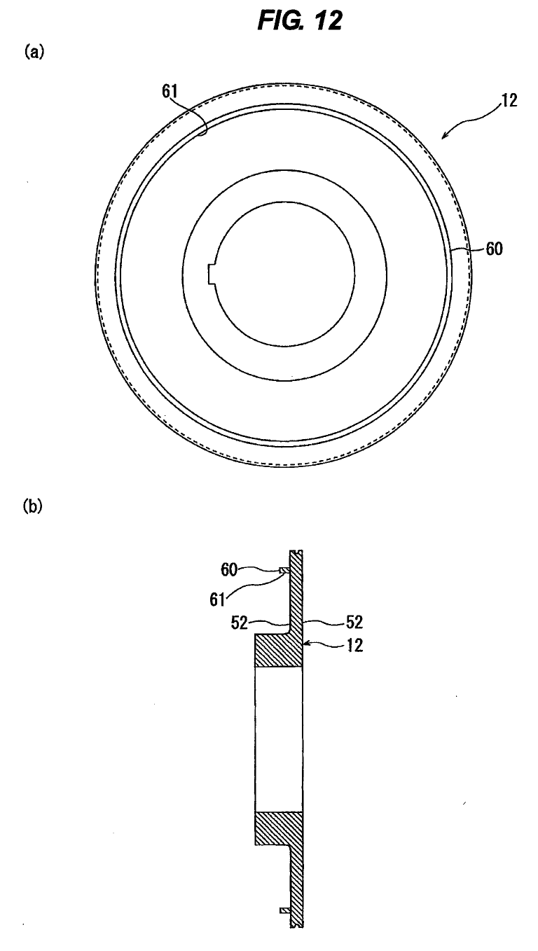

As shown in FIGS. 12(a) and 12(b), a circumferential wall 60 projecting in the axial direction of the rotational shaft 1 from the side surface 52 of the oil disk 12 toward the bearing unit 9A may be provided instead of the grooves 50. FIG. 12(a) is a plan view of an oil disk 12 according to another embodiment of the present invention, and FIG. 12(b) is a vertical cross-sectional view of the oil disk 12 shown in FIG. 12(a). As with the outer-circumferential-side end surface 51 of the groove 50, an inner circumferential surface 61 of the circumferential wall 60 extends parallel to the axial direction of the rotational shaft 1. By providing such circumferential wall 60 projecting in the axial direction of the rotational shaft 1 from the side surface 52 of the oil disk 12, the same advantageous effects as the grooves 50 can be achieved. Specifically, the lubricating oil on the side surface 52 of the oil disk 12 is moved radially outwardly by the strong centrifugal force, and is then prevented from moving by the inner circumferential surface 61 of the circumferential wall 60. Therefore, the lubricating oil is prevented from being scattered outwardly in the radial direction of the oil disk 12 by the inner circumferential surface 61 of the circumferential wall 60. Furthermore, since the lubricating oil that has collides with the circumferential wall 60 is caused to change its direction of movement by the inner circumferential surface 61 which extends parallel to the axial direction of the rotational shaft 1, the lubricating oil can be scattered in the axial direction of the rotational shaft 1. In this manner, the inner circumferential surface 61 constitutes a guide surface for changing the direction of movement of the lubricating oil on the side surface 52 from the radial direction of the oil disk 12 to the axial direction of the rotational shaft 1. The inner circumferential surface 61 of the circumferential wall 60 may be constituted by large-diameter portions 57 and small-diameter portions 58, as with the embodiment shown in FIG. 11.

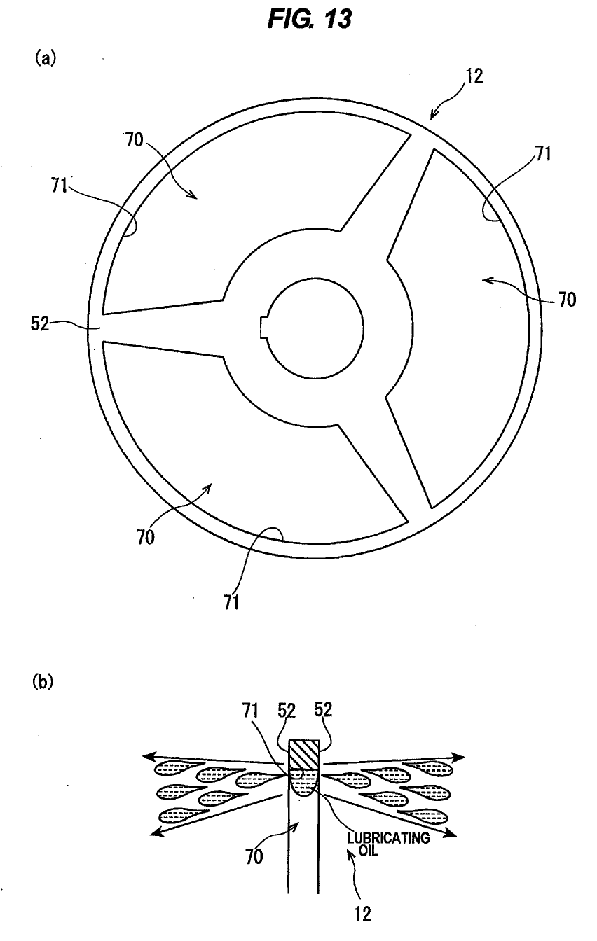

FIG. 13(a) is a plan view of an oil disk 12 according to still another embodiment of the present invention, and FIG. 13(b) is a partial cross-sectional view of the oil disk 12 shown in FIG. 13(a). In the embodiment shown in FIGS. 13(a) and 13(b), the oil disk 12 has a plurality of through-holes 70 extending from one side surface (first side surface) 52 to the other side surface (second side surface) 52 of the oil disk 12. These through-holes 70 are arranged around the axis of the oil disk 12 (i.e., the rotational shaft 1) at equal intervals. Each of the through-holes 70 extends in the circumferential direction of the oil disk 12. The through-holes 70 have outer-circumferential-side surfaces 71 connected to the both side surfaces 52 of the oil disk 12. The through-holes 70 are the same as the grooves 50 in the oil disk 12 according to the embodiment shown in FIGS. 7(a) and 7(b) in that the outer-circumferential-side surfaces 71 extend parallel to the axial direction of the rotational shaft 1, but are different in that the bottom surfaces 56 of the grooves 50 are not provided.

The outer-circumferential-side surface 71 of the through-hole 70 produces the same advantageous effects as the outer-circumferential-side end surfaces 51 of the grooves 50. Specifically, the outer-circumferential-side surface 71 of the through-hole 70 prevents the lubricating oil, scooped up by the oil disk 12 that rotates at a high speed, from being scattered in the radial direction of the oil disk 12. Further, the lubricating oil is caused by the outer-circumferential-side surface 71 of the through-hole 70 to change its direction of movement to the axial direction of the rotational shaft 1, and thus is scattered from the oil disk 12 in the axial direction of the rotational shaft 1. In this manner, the outer-circumferential-side surface 71 constitutes a guide surface for changing the direction of movement of the lubricating oil from the radial direction of the oil disk 12 to the axial direction of the rotational shaft 1.

As shown in FIG. 13(b), the through-hole 70 enables the lubricating oil scooped up by the oil disk 12 to be scattered in the axial direction of the rotational shaft 1 from the both side surfaces 52 of the oil disk 12. Therefore, the lubricating oil can be supplied to both the thrust bearing unit 9A and the radial bearing unit 9B which are disposed at both sides of the oil disk 12 in the bearing apparatus. It is possible to optimize the amount of lubricating oil held in the through-holes 70 by appropriately setting the thickness of the oil disk 12 and the circumferential lengths of the through holes 70. As a result, the amount of lubricating oil supplied to the bearing units 9A, 9B can be optimized. The outer-circumferential-side surface 71 of the through-hole 70 may be constructed by large-diameter portions 57 and small-diameter portions 58, as with the embodiment shown in FIG. 11.

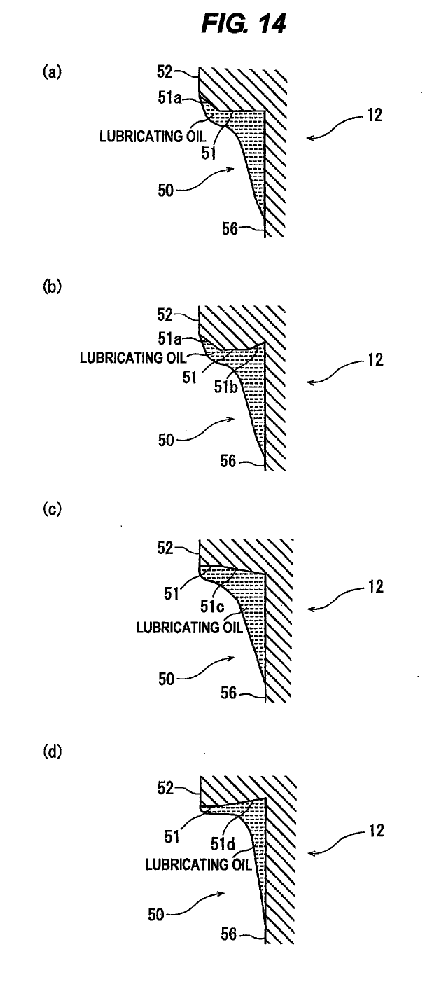

FIGS. 14(a) through 14(d) are views showing cross-sectional shapes of outer-circumferential-side end surfaces 51 of grooves 50 according to various modified examples. The outer-circumferential-side end surfaces 51 shown in FIGS. 14(a) through 14(d) have slope surfaces which are inclined obliquely with respect to the axial direction of the rotational shaft 1. The outer-circumferential-side end surface 51 of the groove 50 shown in FIG. 14(a) has a slope surface 51a that is inclined outwardly toward a side surface (first side surface) 52. This slope surface 51a is connected to the side surface 52 of the oil disk 12. The slope surface 51a imparts a velocity component directed outwardly in the radial direction of the oil disk 12 to the lubricating oil to be scattered from the outer-circumferential-side end surface 51 of the groove 50. Therefore, the scattering distance of the lubricating oil in the axial direction of the rotational shaft 1 can be controlled by adjusting an angle of inclination of the slope surface 51a.

The outer-circumferential-side end surface 51 of the groove 50 shown in FIG. 14(b) has a slope surface 51a that is inclined outwardly toward the side surface 52 and further has a slope surface 51b that is inclined inwardly from the bottom surface 56 of the groove 50 toward the side surface 52. The slope surface 51a is connected to the side surface 52 of the oil disk 12, and the slope surface 51b is connected to the bottom surface 56. Providing the slope surface 51b makes it difficult for the lubricating oil that has moved radially outwardly in the groove 50 to change its direction of movement to the axial direction of the rotational shaft 1. As a result, the amount of lubricating oil scattered in the axial direction of the rotational shaft 1 and the timing of scattering of the lubricating oil in the axial direction of the rotational shaft 1 can be adjusted. As described with respect to the embodiment shown in FIG. 14(a), the slope surface 51a imparts a velocity component directed outwardly in the radial direction of the oil disk 12 to the lubricating oil to be scattered from the outer-circumferential-side end surface 51 of the groove 50. Therefore, the scattering distance of the lubricating oil in the axial direction of the rotational shaft 1 can be controlled by adjusting the angle of inclination of the slope surface 51a.

The outer-circumferential-side end surface 51 of the groove 50 shown in FIG. 14(c) has a slope surface 51c that is inclined outwardly from the bottom surface 56 of the groove 50 toward the side surface 52. This slope surface 51c is connected to the bottom surface 56. The outer-circumferential-side end surface 51 of the groove 50 shown in FIG. 14(d) has a slope surface 51d that is inclined inwardly from the bottom surface 56 of the groove 50 toward the side surface 52. This slope surface 51d is connected to the bottom surface 56.

The cross-sectional shape shown in FIG. 14(c) is a cross-sectional shape that makes it easy to change the direction of movement of the lubricating oil in the groove 50 from the radial direction of the oil disk 12 to the axial direction of the rotational shaft 1. In contrast, the cross-sectional shape shown in FIG. 14(d) is a cross-sectional shape that makes it difficult to change the direction of movement of the lubricating oil in the groove 50 to the axial direction of the rotational shaft 1. In this manner, by controlling the ease with which the lubricating oil in the groove 50 changes its direction of movement from the radial direction of the oil disk 12 to the axial direction of the rotational shaft 1, the timing of scattering of the lubricating oil and the amount of lubricating oil that is scattered can be adjusted. The cross-sectional shapes shown in FIGS. 14(c) and 14(d) are advantageous when the timing of scattering of the lubricating oil and the amount of lubricating oil that is scattered arc to be adjusted with use of other components disposed in the bearing apparatus.

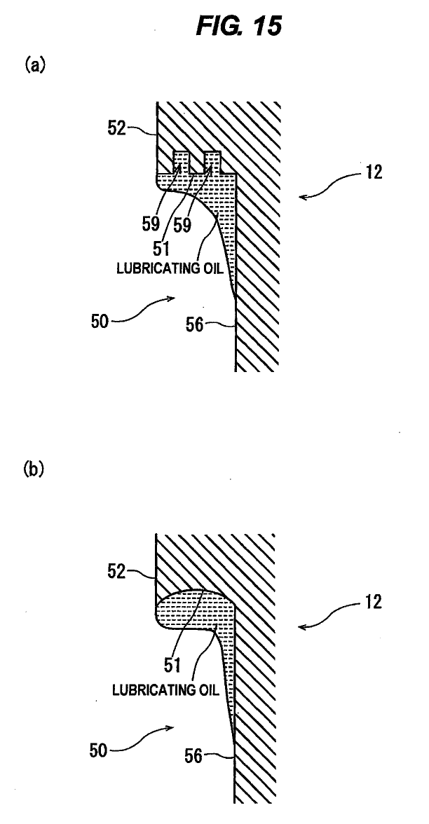

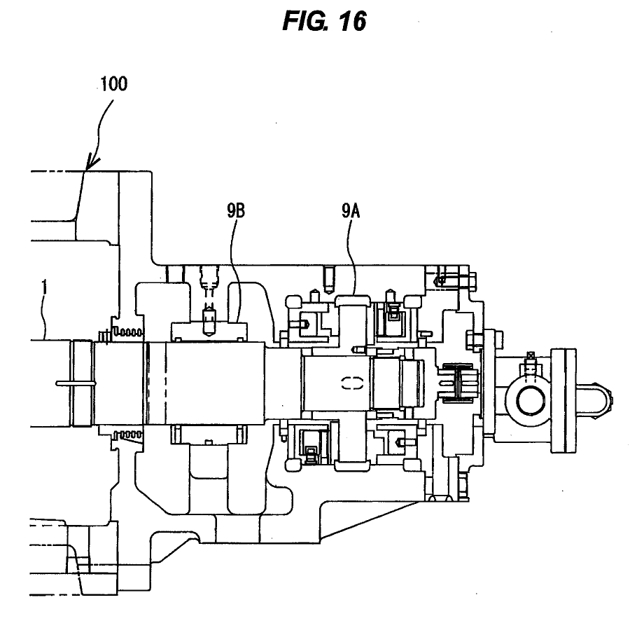

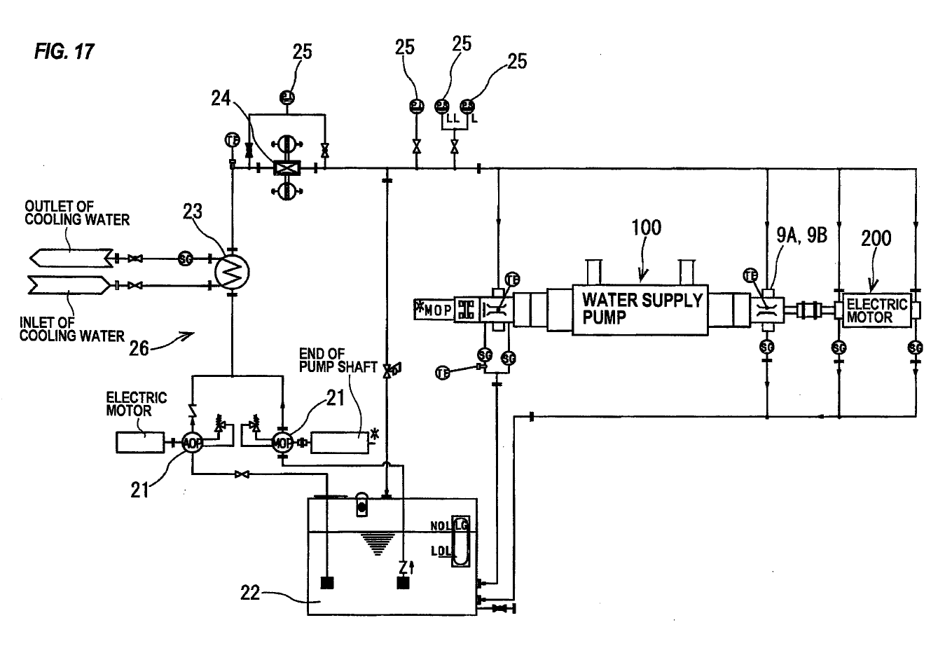

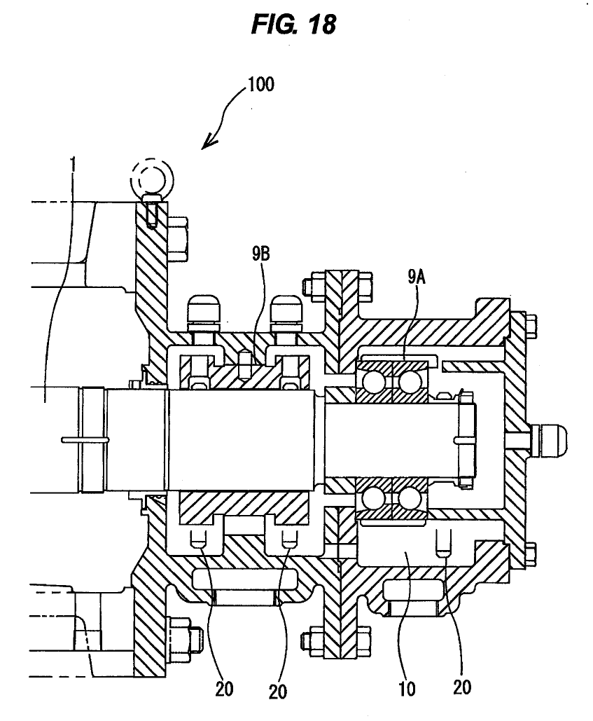

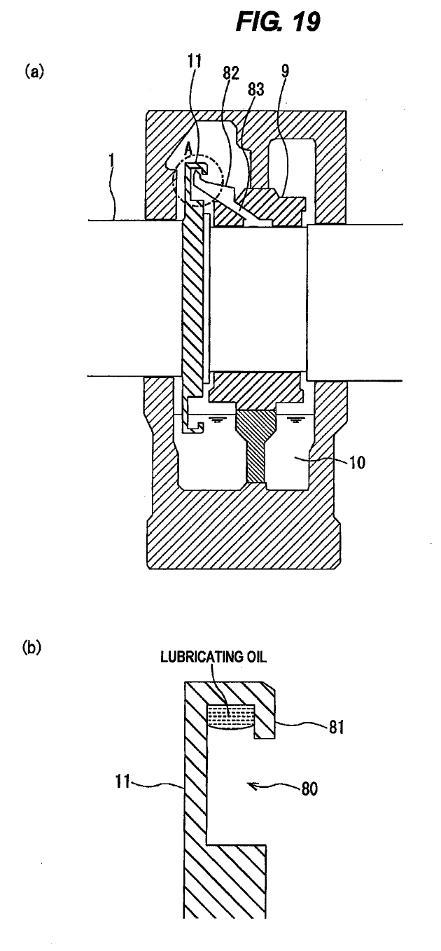

FIGS. 15(a) and 15(b) are views showing cross-sectional shapes of outer-circumferential-side end surfaces 51 of grooves 50 according to still another modified examples. FIG. 15(a) shows the cross-sectional shape of the outer-circumferential-side end surface 51 of the groove 50 which has grooves 59 extending in the circumferential direction of the oil disk 12. Although two grooves 59 are forming in the illustrated example, one or three or more grooves 59 may be formed. By providing the grooves 59, it is possible to adjust the amount of lubricating oil held on the outer-circumferential-side end surface 51 of the groove 50, thereby adjusting the amount of lubricating oil supplied to the bearing unit 9A.

FIG. 15(b) shows the cross-sectional shape of the outer-circumferential-side end surface 51 of the groove 50 which is constituted by a curved surface that is concave radially outwardly. The outer-circumferential-side end surface 51 having the curved shape makes it possible to adjust the amount of lubricating oil held on the outer-circumferential-side end surface 51 of the groove 50, thereby adjusting the amount of lubricating oil supplied to the bearing unit 9A.

The cross-sectional shapes shown in FIGS. 14(a) through 14(d) and the cross-sectional shapes shown in FIGS. 15(a) and 15(b) may be applied to the inner circumferential surface 61 of the circumferential wall 60 shown in FIGS. 12(a) and 12(b). Furthermore, the cross-sectional shapes shown in FIGS. 14(a) through 14(d) and the cross-sectional shapes shown in FIGS. 15(a) and 15(b) may be applied to the outer-circumferential-side surface 71 of the through-hole 70 shown in FIGS. 13(a) and 13(b).

According to the embodiments described thus far, even under the high-peripheral-speed conditions in which it has been difficult for the conventional oil ring and oil disk to supply the lubricating oil, it is possible to supply the lubricating oil stably to the bearing unit 9A in the bearing apparatus with a simple arrangement wherein the groove 50, the circumferential wall 60, or the through-hole 70 is provided in or on the oil disk 12. Therefore, since the applicable range of the bearing apparatus is widened without using a forced oil supply apparatus, the installation area for pump is reduced and the cost of the pump is lowered, so that it is possible to provide a pump which is highly competitive.

Although the embodiments according to the present invention have been described above, it should be understood that the present invention is not limited to the above embodiments, and various changes and modifications may be made within the technical concept of the appended claims. Needless to say, the present invention is applicable to various types of rotary machines by appropriately designing the shapes and sizes of the outer-circumferential-side end surface 51 of the groove 50, the inner circumferential surface 61 of the circumferential wall 60, or the outer-circumferential-side surface 71 of the through-hole 70 which is provided in or on the oil disk 12, depending on operating conditions, such as the rotational speed of the rotational shaft 1, of the rotary machines, and property values such as the viscosity of the lubricating oil.

### INDUSTRIAL APPLICABILITY

The present invention is applicable to a bearing apparatus which is capable of appropriately supplying lubricating oil to a bearing even if a rotational shaft becomes larger in diameter or a rotational speed thereof is higher. The present invention is also applicable to a pump including such a bearing apparatus.

### REFERENCE SIGNS LIST

1 rotational shaft
2 impeller
3 suction port
4 discharge port
5 pump casing
6 guide vane
7 balancing device
8 shaft seal device (mechanical seal)
9 bearing apparatus
9A thrust bearing unit
9B radial bearing unit
10 lubricating oil reservoir
10A free surface (lubricating oil surface)
11, 12, 101 oil disk
14 radial groove
15 guide casing
16 lubricating oil introducing groove
17 lubricating oil passage
20 oil ring
21 oil pump
22 oil tank
23 oil cooler
24 filter
25 monitoring device
26 forced oil supply apparatus
27 cooling jacket
50 groove
51 outer-circumferential-side end surface
51a, 51b, 51c, 51d slope surface
52 side surface
55 area where grooves do not exist
56 bottom surface
57 large-diameter portion
58 small-diameter portion
59 groove
60 circumferential wall
61 inner circumferential surface
70 through-hole
71 outer-circumferential-side surface
72 corner
80 recess
81 protrusion
100 horizontal-shaft pump (rotary machine)
200 electric motor

1-12. (canceled)

13. A bearing apparatus comprising:
a bearing unit for receiving a load of a rotational shaft;
a lubricating oil reservoir disposed below the bearing unit; and
an oil disk fixed to the rotational shaft and rotatable together with the rotational shaft to scoop up lubricating oil stored in the lubricating oil reservoir;
wherein the oil disk has a side surface facing the bearing unit, the side surface having a groove formed therein;
an outer-circumferential-side end surface of the groove extends parallel to an axial direction of the rotational shaft;
the outer-circumferential-side end surface constitutes a guide surface for changing a direction of movement of the lubricating oil in the groove from a radial direction of the oil disk to the axial direction of the rotational shaft; and
the outer-circumferential-side end surface is connected to the side surface of the oil disk.

14. The bearing apparatus according to claim 13, wherein the groove comprises a plurality of grooves arranged around an axis of the oil disk.

15. The bearing apparatus according to claim 13, wherein the outer-circumferential-side end surface comprises a large-diameter portion and a small-diameter portion located at different distances from the center of the oil disk.

16. The bearing apparatus according to claim 13, wherein the outer-circumferential-side end surface has a slope surface which is inclined obliquely with respect to the axial direction of the rotational shaft.

17. A bearing apparatus comprising:
a bearing unit for receiving a load of a rotational shaft;
a lubricating oil reservoir disposed below the bearing unit; and
an oil disk fixed to the rotational shaft and rotatable together with the rotational shaft to scoop up lubricating oil stored in the lubricating oil reservoir;
wherein the oil disk has a side surface facing the bearing unit, the side surface having a circumferential wall projecting toward the bearing unit and extending around the rotational shaft;
an inner circumferential surface of the circumferential wall extends parallel to an axial direction of the rotational shaft; and
the inner circumferential surface of the circumferential wall constitutes a guide surface for changing a direction of movement of the lubricating oil on the side surface of the oil disk from a radial direction of the oil disk to the axial direction of the rotational shaft.

18. The bearing apparatus according to claim 17, wherein the inner circumferential surface of the circumferential wall comprises a large-diameter portion and a small-diameter portion located at different distances from the center of the oil disk.

19. The bearing apparatus according to claim 17 wherein the inner circumferential surface of the circumferential wall has a slope surface which is inclined obliquely with respect to the axial direction of the rotational shaft.

20. A bearing apparatus comprising:
a bearing unit for receiving a load of a rotational shaft;
a lubricating oil reservoir disposed below the bearing unit; and
an oil disk fixed to the rotational shaft and rotatable together with the rotational shaft to scoop up lubricating oil stored in the lubricating oil reservoir;
wherein the oil disk has a first side surface facing the bearing unit, a second side surface located opposite to the first side surface, and a plurality of through-holes extending from the first side surface to the second side surface;
the through-holes have outer-circumferential-side surfaces extending parallel to an axial direction of the rotational shaft; and
the outer-circumferential-side surfaces of the through-holes are connected to the first side surface and the second side surface of the oil disk.

21. The bearing apparatus according to claim 20, wherein the outer-circumferential-side surface comprises a large-diameter portion and a small-diameter portion located at different distances from the center of the oil disk.

22. The bearing apparatus according to claim 20, wherein the outer-circumferential-side surface has a slope surface which is inclined obliquely with respect to the axial direction of the rotational shaft.

23. The bearing apparatus according to claim 20, further comprising:
a second bearing unit for receiving the load of the rotational shaft;
wherein the second side surface faces the second bearing unit.

24. A pump comprising:
a rotational shaft;
an impeller fixed to the rotational shaft; and
a bearing apparatus according to claim 1, for rotatably supporting the rotational shaft.
